(19) United States
(12) Patent Application Publication
(10) Pub. No.: US 2025/0083473 A1
(43) Pub. Date: Mar. 13, 2025

(54) WHEEL HUB ASSEMBLIES AND METHODS OF PRODUCING A WHEEL HUB ASSEMBLY

(71) Applicant: ILJIN USA Corporation, Novi, MI (US)

(72) Inventors: Brian Richards, Novi, MI (US); Mason Bennett, Novi, MI (US); Andrew Carey, Novi, MI (US); Byung Taek Kim, Seoul (KR); Gi Han Choi, Seoul (KR)

(73) Assignee: ILJIN USA Corporation, Novi, MI (US)

(21) Appl. No.: 18/243,758

(22) Filed: Sep. 8, 2023

(51) Int. Cl. B60B 27/00; B60B 27/02

(52) U.S. Cl. CPC B60B 27/0078; B60B 27/0052; B60B 27/02; B60B 2320/10

(57) ABSTRACT

Wheel hub assemblies and methods of producing a wheel hub assembly are provided. The wheel hub assembly includes a wheel hub fastened to a wheel of a vehicle, the wheel hub having a rotor mounting surface facing an inboard direction, a disc brake rotor having a mounting surface attached to the rotor mounting surface, the mounting surface facing an outboard direction and a bearing mounted inside the wheel hub. The rotor mounting surface is machined after installation of the bearing inside the wheel hub and fixation of the bearing to the wheel hub by a snap ring such that a runout of the rotor mounting surface is less than or equal to 30 μm.

### TECHNICAL FIELD

The present disclosure relates to wheel hub assemblies and methods of producing a wheel hub assembly.

### BACKGROUND

In general, a wheel hub assembly is a device which supports a wheel so as to be rotatable with respect to a body of a vehicle. That is, a wheel hub assembly includes a non-rotating element fixed to the body of the vehicle, a rotating element fixed to the wheel, and a plurality of rolling bodies provided between the non-rotating element and the rotating element to facilitate the relative rotation of the rotating element with respect to the non-rotating element.

The wheel hub assembly further includes a brake disc mounted to the rotating element. The disc brake rotor is formed in a disc shape and extends radially outward. The disc brake rotor extending radially outward is disposed between a pair of friction pads of a brake device for a vehicle.

As the transition of Original Equipment Manufacturer (OEM) from internal combustion engine (ICE) to electric vehicles (EV) systems, noise and vibration from the disc brake systems has become a concern. The OEMs are requiring better runout control for the hub and the rotor mounting surface of the vehicles, such as truck, trailer, or both, like the traditional automotive hub and bearing assemblies. However, the cast hub of the vehicles, such as truck, trailer, or both, has an inboard rotor mounting surface, which has limited surface area. Moreover, rotor bolt holes in the wheel hub assembly make the post assembly machining process difficult.

Accordingly, a need exists for wheel hub assembly and methods of producing a wheel assembly that reduce noise and vibration from the disc brake rotor.

### SUMMARY

The present disclosure provides wheel hub assemblies and methods of producing a wheel hub assembly. The wheel hub assemblies and methods of producing wheel hub assemblies reduce noise and vibration from the disc brake rotor by machining a rotor mounting surface of the wheel hub and flange surface of a flange and attaching a mounting surface of disc brake rotor to the rotor mounting surface. The wheel hub assemblies and methods of producing wheel hub assemblies may include an inboard machined rotor mounting surface instead of machining the outboard hub flange surface like a traditional automotive wheel hub assembly to reduce noise and vibration from the disc brake rotor. With reducing noise and vibration from disc brake rotor, the wheel hub assemblies may be suitable for vehicles such as, truck, trailer, or both. Moreover, with reducing noise and vibration from disc brake rotor, the wheel hub assemblies may be suitable for electric vehicles.

In one or more embodiments, a wheel hub assembly includes a wheel hub fastened to a wheel of a vehicle, the wheel hub having a rotor mounting surface facing an inboard direction, and a disc brake rotor having a mounting surface attached to the rotor mounting surface, the mounting surface facing an outboard direction. The wheel hub includes a cylindrical portion and a flange formed to extend radially outward from the cylindrical portion and to continuously extend in a circumferential direction, the flange having a flange surface facing the outboard direction. The rotor mounting surface is machined after installation of the bearing inside the wheel hub and fixation of the bearing by a snap ring such that a runout of the rotor mounting surface is less than or equal to 30 micrometers (μm).

In another embodiment, a method of producing a wheel hub assembly includes assembling a bearing to a wheel hub comprising a flange having a flange surface facing an outboard direction, the wheel hub having a rotor mounting surface facing an inboard direction, machining the rotor mounting surface such that a runout of the rotor mounting surface is less than or equal to 30 μm, and attaching a mounting surface of a disc brake rotor to the rotor mounting surface, the mounting surface facing the outboard direction.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is an exploded perspective view of a wheel hub assembly, according to one or more embodiments shown and described herein;

FIGS. 2A and 2B are a cross-sectional side elevation view of the wheel hub assembly;

FIG. 3 depicts a flowchart for methods of producing a wheel hub assembly, according to one or more embodiments shown and described herein; and

FIG. 4 depicts a flowchart for methods of producing a wheel hub assembly, according to another embodiment shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The embodiments disclosed herein include wheel hub assemblies and methods of producing a wheel hub assembly. The wheel hub assemblies and methods of producing wheel hub assemblies reduce noise and vibration from the disc brake rotor by machining a rotor mounting surface of the wheel hub and flange surface of a flange and attaching a mounting surface of disc brake rotor to the rotor mounting surface. The wheel hub assemblies and methods of producing wheel hub assemblies may include a machined rotor mounting surface as well as a machined flange surface to reduce noise and vibration from the disc brake rotor. With reducing noise and vibration from disc brake rotor, the wheel hub assemblies may be suitable for vehicles such as, truck, trailer, or both. Moreover, with reducing noise and vibration from disc brake rotor, the wheel hub assemblies may be suitable for electric vehicles.

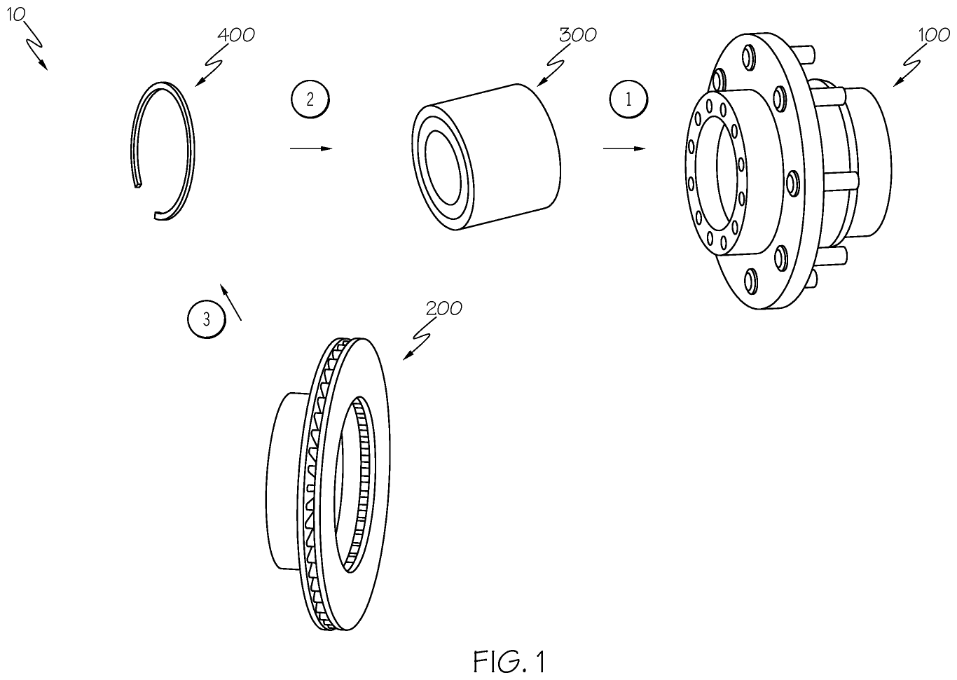

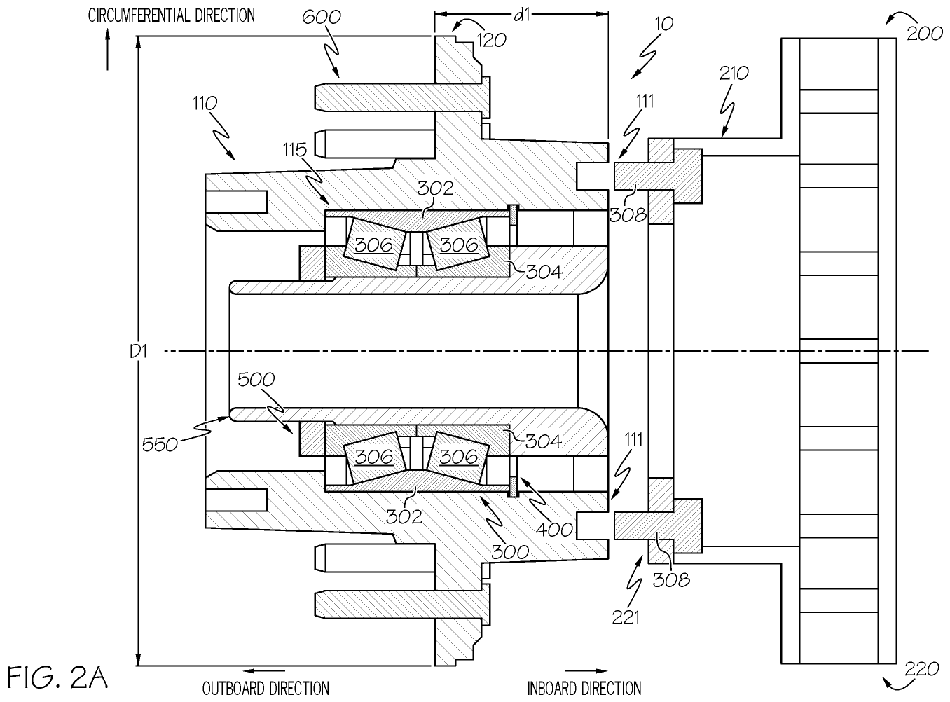

FIG. 1 an exploded perspective view of a wheel hub assembly, according to one or more embodiments shown and described herein. FIGS. 2A and 2B are a cross-sectional side elevation view of the wheel hub assembly.

Referring to FIGS. 1, 2A, and 2B, the wheel hub assembly 10 includes a wheel hub 100 and a disc brake rotor 200. The disc brake rotor 200 may be fastened to the wheel hub 100 so as to rotate as a unit.

The wheel hub 100 may be fastened to a wheel of a vehicle. The vehicle may be a heavy-duty truck. The heavy-duty trucks may include trucks and tractor-trailers or semi-trailers, and the tractor-trailers or semi-trailers typically are equipped with one or more trailers. Throughout, reference shall be made to a heavy-duty vehicle with the understanding that such reference includes trucks, tractor-trailers and semi-trailers, and trailers. The heavy-duty truck may refer a vehicle having a gross vehicle weight rating over 8,500 pounds, over 10,000 pounds, 15,000 pounds, 20,000 pounds, or 25,000 pounds.

In some embodiments, the vehicle may be a truck, a trailer, or both. The vehicle may be an electric vehicle. In some embodiments, the vehicle may be an electric truck, an electric trailer, or both. The vehicle may be an electric heavy-duty truck.

In some embodiments, the wheel hub 100 may be made through a casting process using a ductile iron or aluminum materials, best to leave this material options open if possible.

In some embodiments, the wheel hub 100 may have an outside diameter D1 of greater than or equal to 180 mm, greater than or equal to 190 mm, or greater than or equal to 200 mm. In some embodiments, the wheel hub 100 may have an outside diameter D1 of less than or equal to 350 mm, less than or equal to 345 mm, less than or equal to 340 mm, or less than or equal to 338 mm. The distance d1 between the flange surface 121 and the rotor mounting surface 111 may be from 180 mm to 350 mm, from 180 mm to 345 mm, from 180 mm to 340 mm, from 180 mm to 338 mm, from 190 mm to 350 mm, from 190 mm to 345 mm, from 190 mm to 340 mm, from 190 mm to 338 mm, from 200 mm to 350 mm, from 200 mm to 345 mm, from 200 mm to 340 mm, from 200 mm to 338 mm, or any and all sub-ranges formed from any of these endpoints.

The wheel hub 100 may have a rotor mounting surface 111. The rotor mounting surface 111 may face an inboard direction. The inboard direction may refer a direction from a wheel of the vehicle to inside of the vehicle.

In some embodiments, the rotor mounting surface 111 is machined after installation of the bearing 300 inside the wheel hub 100 and fixation of the bearing 300 to the wheel hub 100 by a snap ring 400 such that a runout (a deflection amount with respect to a reference plane) of the rotor mounting surface 111 is less than or equal to 30 micrometers (μm), less than or equal to 29 μm, less than or equal to 28 μm, less than or equal to 27 μm, less than or equal to 26 μm, or less than or equal to 25 μm. Specifically, the bearing 300 is fixed inside the wheel hub 100 by the snap ring 400 as illustrated in FIG. 1. Then, the bearing 300 is installed on a spindle 550. After the bearing 300 is installed on the spindle 550, the wheel hub 100 which is integrated with the bearing 300 is rotated and the rotor mounting surface 111 of the wheel hub 100 is machined in order to reduce the runout of the rotor mounting surface 111. The runout may refer to an inaccuracy of rotating mechanical systems, specifically that the tool or shaft does not rotate exactly in line with the main axis. With machining the rotor mounting surface 111, the wheel hub assembly 10 may restore flat, smooth surfaces to provide the proper friction needed, minimizing noise-producing vibrations and allowing for maximum pad contact.

The wheel hub 100 may include a cylindrical portion 110 and a flange 120. The cylindrical portion 110 may have two sides that are open and face opposite directions along an axis direction. The axis direction may refer to either the inboard direction or the outboard direction. The flange 120 may be formed integrally with the cylindrical portion 110 so as to extend radially outward from the cylindrical portion 110.

The flange 120 may have a shape widening radially outward from the cylindrical portion 110 and continuously extending in the circumferential direction.

The flange 120 may have a flange surface 121. The flange surface 121 may face the outboard direction. The outboard direction may refer a direction from inside of the vehicle to a wheel of the vehicle.

In embodiments, the flange surface 121 does not need to be machined after installation of the bearing 300 inside the hub. In some embodiments, the flange surface 121 may be machined such that a runout of the flange surface 121 is less than or equal to 25 μm, less than or equal to 24 μm, less than or equal to 23 μm, less than or equal to 22 μm, less than or equal to 21 μm, or less than or equal to 20 μm. With machining the flange surface 121, the wheel hub assembly 10 may restore flat, smooth surfaces to provide the proper friction needed, minimizing noise-producing vibrations and allowing for maximum pad contact.

In another embodiment, a brake rotor may be mounted on the outboard side of the flange of the wheel hub and the wheel rim. In this embodiment, the flange surface of wheel hub may be machined after installing the bearing inside the wheel hub in order to control axial runout of the flange surface.

In some embodiments, a distance dl between the flange surface 121 and the rotor mounting surface 111 may be greater than or equal to 50 mm, greater than or equal to 55 mm, or greater than or equal to 60 mm. In some embodiments, a distance d1 between the flange surface 121 and the rotor mounting surface 111 may be less than or equal to 160 mm, less than or equal to 158 mm, less than or equal to 155 mm, or less than or equal to 153.6 mm. A distance d1 between the flange surface 121 and the rotor mounting surface 111 may be from 50 mm to 160 mm, from 50 mm to 158 mm, from 50 mm to 155 mm, from 50 mm to 153.6 mm, from 55 mm to 160 mm, from 55 mm to 158 mm, from 55 mm to 155 mm, from 55 mm to 153.6 mm, from 60 mm to 160 mm, from 60 mm to 158 mm, from 60 mm to 155 mm, from 60 mm to 153.6 mm, or any and all sub-ranges formed from any of these endpoints.

In some embodiments, the wheel hub assembly 10 may further include a flange bolt 600. The flange bolt 600 may penetrate the flange 120 in the outboard direction. The flange bolt 600 may include a head and a body. The body may be extended from the head to the outboard direction. In some embodiments, the wheel hub assembly 10 may include a plurality of flange bolts 600.

Still referring to FIGS. 1, 2A, and 2B, the disc brake rotor 200 may be fastened to the wheel hub 100. The disc brake rotor 200 may be fastened to the wheel hub 100 by a plurality of disc bolts 308 so that the disc brake rotor 200 may be separated from the wheel hub 100 in case the disc brake rotor 200 is repaired or replaced due to wear, etc.

In some embodiments, the disc brake rotor 200 may be made by a casting method using, for example, a grey cast iron material.

The disc brake rotor 200 may include two sliding portions 220 generating frictional brake force by selectively coming into contact with brake pads (friction materials), not shown, in response to a braking operation.

The two sliding portions 220 are disposed axially spaced apart from one another. The two sliding portion may face opposite directions along the circumferential direction.

One of the two sliding portions 220 includes a mounting surface 221. The mounting surface 221 faces the outboard direction. The mounting surface 221 is attached to the rotor mounting surface 111 of the wheel hub 100. The rotor mounting surface 111 of the wheel hub 100 faces the inboard direction. The mounting surface 221 is contacted with the rotor mounting surface 111 of the wheel hub 100.

A plurality of ribs may be formed between the two sliding portions 220. The two sliding portions 220 may be integrally connected through the ribs.

The plurality of ribs may be disposed at fixed intervals in the circumferential direction to form air passages between the plurality of ribs. In some embodiments, by facilitating smooth air circulation through the air passages, the air cooling effect of the disc brake rotor 200 may be improved.

An annular ring portion 210 may be formed to protrude from one of the sliding portions 220. The annular ring portion 210 may include the mounting surface 221. The annular ring portion 210 may include a plurality of holes. The plurality of holes in the annular ring portion 210 may correspond to a plurality of holes in the cylindrical portion 110.

The wheel hub 100 and the disc brake rotor 200 may be fastened together by attaching the mounting surface 221 of the disc brake rotor 200 to the rotor mounting surface 111. The mounting surface 221 is an annular surface that corresponds to the rotor mounting surface 111. The disc brake rotor 200 may be fixed to the wheel hub 100 by a plurality of disc bolts 308 that go through the plurality of holes in the annular ring portion 210 and the plurality of holes in the wheel hub 100. The plurality of disc bolts 308 may penetrate both the wheel hub 100 and the disc brake rotor 200.

The rotor mounting surface 111 of the wheel hub assembly 10 is machined such that a runout of the rotor mounting surface 111 is less than or equal to 30 μm. The flange surface 121 of the wheel hub assembly 10 is not machined. The outside diameter D1 of the wheel hub 100 is from 180 mm to 350 mm. The distance d1 between the flange surface 121 and the rotor mounting surface 111 is from 50 mm to 160 mm. This specific structure of the wheel hub assembly 10 may improve a judder phenomenon of the brake device caused by a run-out defect as well as reduce squeal noise.

In some embodiments, the rotor mounting surface 111 of the wheel hub assembly 10 is machined such that a runout of the rotor mounting surface 111 is less than or equal to 30 μm. The flange surface 121 of the wheel hub assembly 10 is machined such that a runout of the flange surface 121 is less than or equal to 25 μm. The outside diameter DI of the wheel hub 100 is from 180 mm to 350 mm. The distance d1 between the flange surface 121 and the rotor mounting surface 111 is from 50 mm to 160 mm. This specific structure of the wheel hub assembly 10 may improve a judder phenomenon of the brake device caused by a run-out defect as well as reduce squeal noise.

In some embodiments, the rotor mounting surface 111 of the wheel hub assembly 10 is machined such that a runout of the rotor mounting surface 111 is less than or equal to 25 μm. The flange surface 121 of the wheel hub assembly 10 is not machined. The outside diameter D1 of the wheel hub 100 is from 220 mm to 338 mm. The distance d1 between the flange surface 121 and the rotor mounting surface 111 is from 60 mm to 153.6 mm. The specific structure of the wheel hub assembly 10 may improve a judder phenomenon of the brake device caused by a run-out defect as well as reduce squeal noise.

In some embodiments, the rotor mounting surface 111 of the wheel hub assembly 10 is machined such that a runout of the rotor mounting surface 111 is less than or equal to 25 μm. The flange surface 121 of the wheel hub assembly 10 is machined such that a runout of the flange surface 121 is less than or equal to 20 μm. The outside diameter D1 of the wheel hub 100 is from 220 mm to 338 mm. The distance d1 between the flange surface 121 and the rotor mounting surface 111 is from 60 mm to 153.6 mm. The specific structure of the wheel hub assembly 10 may improve a judder phenomenon of the brake device caused by a run-out defect as well as reduce squeal noise.

As described above, the wheel hub assembly 10 may include the bearing 300. The bearing 300 may be mounted inside the wheel hub 100. The bearing 300 may be mounted inside the wheel hub 100 prior to machining the rotor mounting surface 111. The bearing 300 may be mounted inside the wheel hub 100 prior to mounting the snap ring 400 in the wheel hub 100.

The bearing 300 includes an outer ring 302 and an inner ring 304. When the bearing 300 is mounted inside the wheel hub 100, the outer ring 302 may be disposed against the inner wall 115 of the cylindrical portion 110. A plurality of rolling elements 360 (e.g., balls, rollers such as tapered rollers, or the like) rotatably couple the outer ring 302 to the inner ring 304.

In embodiments, the wheel hub assembly 10 may further include a spindle 550. The spindle 550 may be mounted inside the wheel hub 100. The spindle 550 is inserted into the inner ring 304 and fixed by the clamping device 500 such the inner ring 304 is fixed to the spindle 550 and the outer ring 302 rotates against the inner ring 304 and the spindle 550. The assembled bearing and wheel hub may be mounted on the spindle 550 prior to machining the rotor mounting surface 111.

In embodiments, the wheel hub assembly 10 may further include a snap ring 400. The snap ring 400 may be mounted inside the wheel hub 100. The snap ring 400 may be disposed and attached to the outer ring 302 to fix the outer ring 302 against the cylindrical portion 110. The snap ring 400 may be mounted inside the wheel hub 100 to fix the bearing 300 inside the wheel hub 100 prior to machining the rotor mounting surface 111. The snap ring 400 may be mounted inside the wheel hub 100 prior to mounting the snap ring 400 in the wheel hub 100.

In embodiments, the wheel hub assembly 10 may further include a clamping device 500. The clamping device 500 may be mounted inside the wheel hub 100. The clamping device 500 may be configured to fix the bearing 300, more specifically, to fix the inner ring 304 against the spindle 550. The clamping device 500 may be, for example, a nut. The clamping device 500 may be mounted inside the wheel hub 100 prior to machining the rotor mounting surface 111.

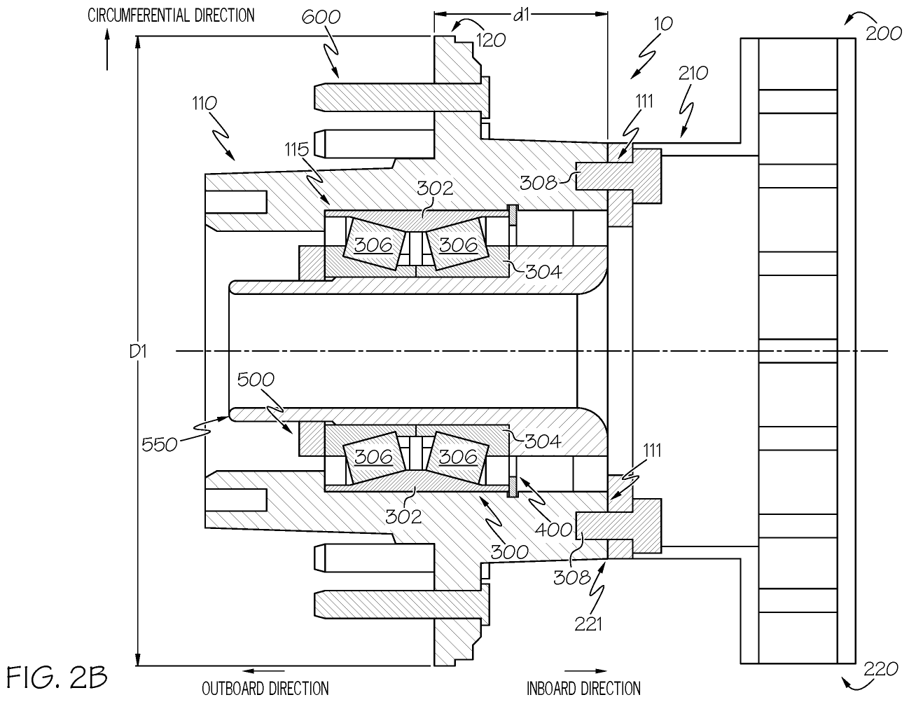

FIG. 3 depicts a flowchart for methods of producing a wheel hub assembly, according to one or more embodiments shown and described herein.

Referring to FIGS. 1-3, in step S310, a bearing 300 is assembled to a wheel hub 100. The wheel hub 100 may include a cylindrical portion 110 and a flange 120. The cylindrical portion 110 may have two sides that are open and face opposite directions along an axis direction. The axis direction may refer to either the inboard direction or the outboard direction. The flange 120 may be formed integrally with the cylindrical portion 110 so as to extend radially outward from the cylindrical portion 110. The flange 120 has a flange surface 121 facing an outboard direction. The wheel hub 100 may have a rotor mounting surface 111. The rotor mounting surface 111 may face an inboard direction. The inboard direction may refer a direction from a wheel of the vehicle to inside of the vehicle.

In embodiments, a snap ring 400 may be mounted inside the wheel hub 100. The snap ring 400 may be disposed and attached to the outer ring 302 to fix the outer ring 302 against the cylindrical portion 110 such that the bearing 300 is fixed within the wheel hub 100. The snap ring 400 may be mounted inside the wheel hub 100 prior to machining the rotor mounting surface 111. Once the bearing 300 is fixed to the wheel hub 100, the bearing 300 is installed on the spindle 550. In embodiments, the assembled bearing and wheel hub may be mounted on a spindle 550 prior to machining the rotor mounting surface 111. The spindle 550 may be mounted inside the wheel hub 100. The spindle 550 is inserted into the inner ring 304 and fixed by the clamping device 500 such the inner ring 304 is fixed to the spindle 550 and the outer ring 302 rotates against the inner ring 304 and the spindle 550.

In embodiments, a clamping device 500 against the bearing 300 may be mounted inside the wheel hub 100 prior to machining the rotor mounting surface 111. The clamping device 500 may be mounted inside the wheel hub 100. The clamping device 500 may be configured to fix the bearing 300. Specifically, the clamping device 500 may fix the inner ring 304 such that the movement of the bearing 300 relative to the spindle 550 is limited.

Still referring to FIGS. 1-3, in step S320, the rotor mounting surface 111 is machined after installation of the bearing 300 inside the wheel hub 100 and fixation of the bearing 300 to the wheel hub 100 by a snap ring 400 such that a runout of the rotor mounting surface 111 is less than or equal to 30 μm. In some embodiments, the rotor mounting surface 111 is machined such that a runout (a deflection amount with respect to a reference plane) of the rotor mounting surface 111 is less than or equal to 30 micrometers (μm), less than or equal to 29 μm, less than or equal to 28 μm, less than or equal to 27 μm, less than or equal to 26 μm, or less than or equal to 25 μm.

In some embodiments, the distance d1 between the flange surface 121 and the rotor mounting surface 111 may be greater than or equal to 50 mm, greater than or equal to 55 mm, or greater than or equal to 60 mm. In some embodiments, a distance d1 between the flange surface 121 and the rotor mounting surface 111 may be less than or equal to 160 mm, less than or equal to 158 mm, less than or equal to 155 mm, or less than or equal to 153.6 mm. A distance d1 between the flange surface 121 and the rotor mounting surface 111 may be from 50 mm to 160 mm, from 50 mm to 158 mm, from 50 mm to 155 mm, from 50 mm to 153.6 mm, from 55 mm to 160 mm, from 55 mm to 158 mm, from 55 mm to 155 mm, from 55 mm to 153.6 mm, from 60 mm to 160 mm, from 60 mm to 158 mm, from 60 mm to 155 mm, from 60 mm to 153.6 mm, or any and all sub-ranges formed from any of these endpoints.

Still referring to FIGS. 1-3, in step S330, a mounting surface 221 of a disc brake rotor 200 is attached to the rotor mounting surface 111 to produce a wheel hub assembly 10 of a vehicle. The mounting surface 221 may face the outboard direction. The wheel hub 100 and the disc brake rotor 200 may be fastened together by attaching the mounting surface 221 of the disc brake rotor 200 to the rotor mounting surface 111. The disc brake rotor 200 may be fixed to the wheel hub 100 by the plurality of disc bolts 308 that go through the plurality of holes in the annular ring portion 210 and the plurality of holes in the wheel hub 100. The plurality of disc bolts 308 may penetrate both the wheel hub 100 and the disc brake rotor 200.

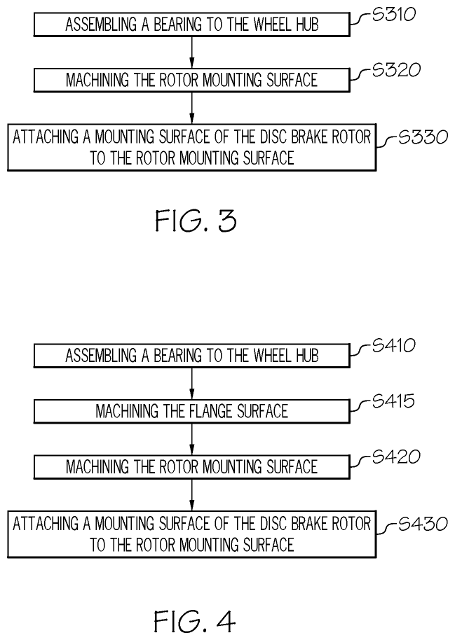

FIG. 4 depicts a flowchart for methods of producing a wheel hub assembly, according to another embodiment shown and described herein.

Referring to FIGS. 1, 2, and 4, in step S410, a bearing 300 is assembled to a wheel hub 100 similar to step 310 in FIG. 3.

In step 415, the flange surface 121 is machined such that a runout of the flange surface 121 is less than or equal to 25 μm. In some embodiments, the flange surface 121 may be machined such that a runout of the flange surface 121 is less than or equal to 25 μm, less than or equal to 24 μm, less than or equal to 23 μm, less than or equal to 110 μm, less than or equal to 21 μm, or less than or equal to 20 μm.

In step 420, the rotor mounting surface 111 is machined after installation of the bearing 300 inside the wheel hub 100 and fixation of the bearing 300 to the wheel hub 100 by a snap ring 400 such that a runout of the rotor mounting surface 111 is less than or equal to 30 μm, similar to S320 in FIG. 3. While this embodiment describes machining the flange surface 121 and the rotor mounting surface 111, any other surface of the wheel hub 100 may be machined after the bearing 300 is fixed inside the wheel hub 100.

In step 430, a mounting surface 221 of a disc brake rotor 200 is attached to the rotor mounting surface 111 to produce a wheel hub assembly 10 of a vehicle, similar to S330 in FIG. 3.

In some embodiments, the vehicle may be a truck, a trailer, or both. The vehicle may be an electric vehicle. In some embodiments, the vehicle may be an electric truck, an electric trailer, or both. The vehicle may be an electric heavy-duty truck.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

What is claimed is:

1. A wheel hub assembly comprising:
a wheel hub fastened to a wheel of a vehicle, the wheel hub having a rotor mounting surface facing an inboard direction;
a disc brake rotor having a mounting surface attached to the rotor mounting surface, the mounting surface facing an outboard direction; and
a bearing mounted inside the wheel hub,
wherein the wheel hub includes a cylindrical portion and a flange formed to extend radially outward from the cylindrical portion and to continuously extend in a circumferential direction, the flange having a flange surface facing the outboard direction, and
wherein the rotor mounting surface is machined after installation of the bearing inside the wheel hub and fixation of the bearing to the wheel hub by a snap ring such that a runout of the rotor mounting surface is less than or equal to 30 micrometers (μm).

2. The wheel hub assembly according to claim 1, wherein the flange surface is machined such that a runout of the flange surface is less than or equal to 25 μm.

3. The wheel hub assembly according to claim 1, wherein an outside diameter of the wheel hub is from 180 millimeters (mm) to 350 mm, and wherein a distance between the flange surface and the rotor mounting surface is from 50 mm to 160 mm.

4. The wheel hub assembly according to claim 1, wherein outside diameter of the wheel hub is from 200 mm to 338 mm.

5. The wheel hub assembly according to claim 1, wherein a distance between the flange surface and the rotor mounting surface is from 60 mm to 153.6 mm.

6. The wheel hub assembly according to claim 1, wherein the runout of the flange surface is less than or equal to 20 μm.

7. The wheel hub assembly according to claim 1, wherein a runout of the rotor mounting surface is less than or equal to 25 μm.

8. The wheel hub assembly according to claim 1, further comprising the snap ring mounted inside the wheel hub,
wherein the snap ring fixes the bearing to the wheel hub and the bearing is installed on a spindle.

9. The wheel hub assembly according to claim 1, further comprising a clamping device mounted inside the wheel hub and configured to fix the bearing.

10. The wheel hub assembly according to claim 1, wherein the vehicle is a heavy-duty truck.

11. The wheel hub assembly according to claim 1, wherein the vehicle is an electric heavy-duty truck.

12. A method of producing a wheel hub assembly comprising:
assembling a bearing to a wheel hub comprising a flange having a flange surface facing an outboard direction, the wheel hub having a rotor mounting surface facing an inboard direction;
fixing the bearing to the wheel hub by a snap ring;
machining the rotor mounting surface such that a runout of the rotor mounting surface is less than or equal to 30 micrometers (μm); and
attaching a mounting surface of a disc brake rotor into the rotor mounting surface, the mounting surface facing the outboard direction.

13. The method of producing the wheel hub assembly according to claim 12, further comprising:
mounting a snap ring inside the wheel hub prior to machining the rotor mounting surface,
wherein the snap ring is disposed between the bearing and the disc brake rotor.

14. The method of producing the wheel hub assembly according to claim 12, further comprising:
mounting the assembled bearing and the wheel hub on a spindle prior to machining the rotor mounting surface; and
mounting a clamping device against the bearing inside the wheel hub prior to machining the rotor mounting surface.

15. The method of producing the wheel hub assembly according to claim 12, wherein the flange surface is machined such that a runout of the flange surface is less than or equal to 25 μm.

16. The method of producing the wheel hub assembly according to claim 12, wherein an outside diameter of the wheel hub is from 180 millimeters (mm) to 350 mm, and wherein a distance between the flange surface and the rotor mounting surface is from 50 mm to 160 mm.

17. The method of producing the wheel hub assembly according to claim 12, wherein the outside diameter of the wheel hub is from 200 mm to 338 mm.

18. The method of producing the wheel hub assembly according to claim 12, wherein a distance between the flange surface and the rotor mounting surface is from 60 mm to 153.6 mm

19. The method of producing the wheel hub assembly according to claim 12, wherein the runout of the flange surface is less than or equal to 20 μm.

20. The method of producing the wheel hub assembly according to claim 12, wherein a runout of the rotor mounting surface is less than or equal to 25 μm.
